(19) United States
(12) Patent Application Publication
(10) Pub. No.: US 2026/0293823 A1
(43) Pub. Date: Oct. 1, 2026

(54) Block Stacking Assembly

(71) Applicant: Jeffrey Hegyi, Auburn Hills, MI (US)

(72) Inventor: Jeffrey Hegyi, Auburn Hills, MI (US)

(21) Appl. No.: 19/574,296

(22) Filed: Mar. 21, 2026

Related U.S. Application Data
(60) Provisional application No. 63/777,831, filed on Mar. 26, 2025.

(51) Int. Cl. A01G 24/44; A01G 24/17; A01G 27/00

(52) U.S. Cl. CPC A01G 24/44; A01G 24/17; A01G 27/00

(57) ABSTRACT

A block stacking assembly secures a starter block of growing medium to an extender block of growing medium, such as rockwool. The block stacking assembly includes first and second base flanges, which are extendable under the extender block such that the extender block secures the block stacking assembly in place. First and second side arms extending upwardly from the first and second bases, respectively. A cross member connects the first side arm to the second side arm over the starter block. The block stacking assembly helps maintain the starter block in a proper position and orientation when stacked upon the extender block of growing medium.

This application claims priority to U.S. Provisional Patent Application to Jeffrey Hegyi entitled “Block stacking assembly,” application Ser. No. 63/777,831, filed Mar. 26, 2025, the disclosures of which are hereby incorporated entirely herein by reference.

### BACKGROUND OF THE INVENTION

### 1. Field of the Invention

This invention relates generally to a device that stabilizes a block used for planting onto another block or slab used for extended growth. More particularly, this invention relates to a stabilizing clip to prevent one block of material from tipping over when stack on another block or slab.

### 2. Description of the Related Art

Plants can be grown in a block of growing medium. The block is of a size that fosters growth of a young plant. After a time, the roots of the plant outgrow the original block. When this happens, the original block of growing medium is placed on another block or slab of growing medium to allow the roots to extend into the underlying block or slab.

When watering the plant, the original block may become top-heavy due to the fact that the roots continue to absorb the water in the original block. With a plant growing above the original block, the original block is susceptible to falling over.

### SUMMARY OF THE INVENTION

A block stacking assembly secures a starter block of growing medium to an extender block of growing medium, such as rockwool. The block stacking assembly includes first and second base flanges, which are extendable under the extender block such that the extender block secures the block stacking assembly in place. First and second side arms extending upwardly from the first and second bases, respectively. A cross member connects the first side arm to the second side arm over the starter block.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is perspective view of one embodiment of the block stacking assembly attached to two blocks of growing medium;

FIG. 2 is perspective view of the embodiment of FIG. 1; and

FIG. 3 is a perspective view of an alternative embodiment of the block stacking assembly.

### DETAILED DESCRIPTION OF EMBODIMENTS OF THE INVENTION

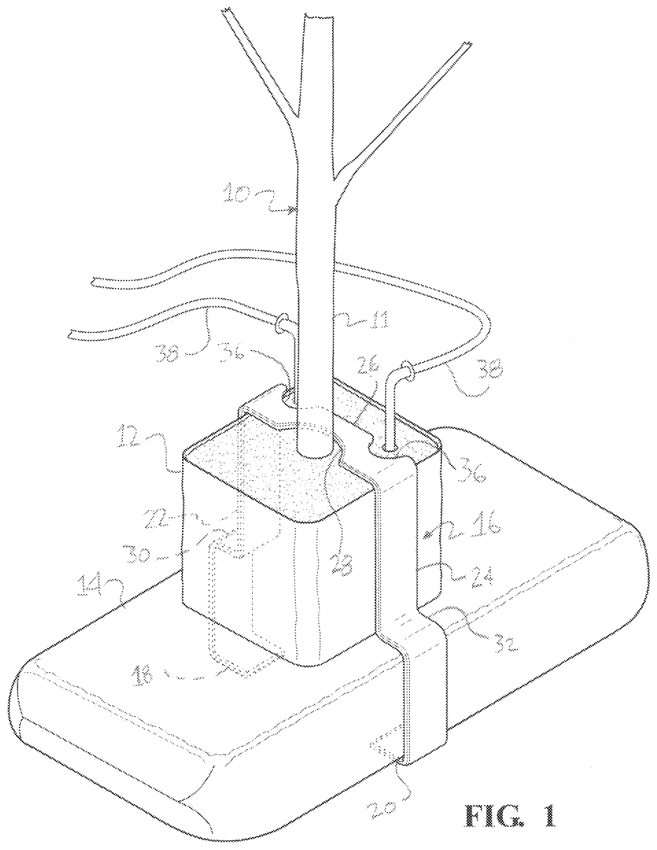

Referring to FIG. 1, a plant is generally shown at 10 growing out of a starter block of growing medium 12. The medium found in the starter block 12 may include rockwool, soil, fertilizer, humus, peat and the like. As the plant 10 grows, an extender block 14 of growing medium may be needed after the roots (not shown) of the plant 10 outgrow the starter block 12. When that happens, the starter block 12 with the plant 10 growing in it is set on top of the extender block or slab 14 allowing the roots to extend into the extender block 14. While not necessary, the extender block 14 is typically wider than the starter block 12. However, because most of the root system is initially in the starter block 10, the starter block 10 has a tendency to tip over while on the extender blocks when the plant 10 collect water in its root system and trunk 11.

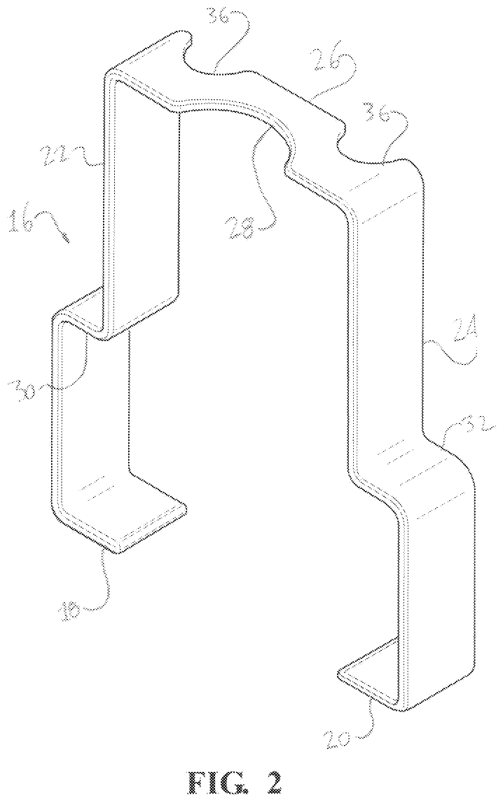

Referring now to FIGS. 1 and 2, one embodiment of a block stacking assembly is generally indicated at 16. The block stacking assembly 16 secures the starter block of growing medium to the extender block of growing medium, inhibiting the starter block (and the plant) from tipping over.

The block stacking assembly 16 includes first 18 and second 20 base flanges. These flanges 18, 20 extend under the extender block 14 such that the extender block 14 secures the block stacking assembly 16 in place by weighing down the base flanges 18, 20.

First 22 and second 24 side arms extend upwardly from the first 18 and second 20 base flanges, respectively. In the embodiment shown, the side arms 22, 24 extend upwardly perpendicularly from their respective base flanges 18, 20. Together, the side arms 22, 24 are coplanar defining a plane. The plane includes the entire length of each of the side arms 22, 24.

The block stacking assembly 16 also includes a cross member 26. The cross member 26 connects the first side arm 16 to the second side arm 20 over or above the starter block. The cross member 26 extends along a path extending in the same plane defined by the side arms 22, 24. More specifically, the cross member 26 and the side arms 22, 24 are all coplanar. While the cross member 26 can meet the side arms 22, 24 at right angles, the preferred embodiment includes a radius of curvature to round out the corners created at the joints.

The cross member 26 includes a trunk relief 28. The trunk relief 28 extends along an arcuate path whereby a portion of the trunk cross member 26 is cut-away. The trunk relief 28 extends along the cross member 26 equidistantly between the first 22 and second 24 side arms.

The trunk relief 28 allows the block staking clip 16 to be mounted over the starter block 12 as close to the middle of the starter block 12. This maximizes the ability of the block stacking clip 16 to maintain the balance of the starter block 12 on top of the extender block 14.

In an alternative embodiment not shown in the Figures, the trunk relief includes at least a portion of the cross member 26 extending through an arcuate path. In this alternative embodiment, the trunk relief is not a cut-away, but a bend in cross member.

Each of the side arms 22, 24 of the block stacking assembly 16 extend through a sidearm bend 30, 32 allowing the block stacking assembly 16 to extend alongside the starter 12 and extender 14 blocks when stacked upon each other and in use. The embodiment of FIG. 1 contemplates the starter block 12 to be narrower than the extender block 14 or slab and is designed to minimize the amount of play between the starter block 12 and the extender block 14 while maintaining the balance of the starter block 12 and plant 10 when stacked over the extender block 14.

The cross member 26 includes at least one waterline cut-away 36, which allows a waterline 38 to be inserted into the growing medium of the starter block 12 as close to the trunk 11 as possible. Having the waterline(s) 38 as close to the trunk 11 and the center of the starter block 12 as possible will minimize any uneven weight distribution of the starter block 12 due to watering of the plant 10. This will, in turn, minimize the potential of tipping the starter block 12 over. In the embodiment shown, there are two waterline cut-aways 36 and two lines 38 (one could be a waterline, and one could be a fertilizer line).

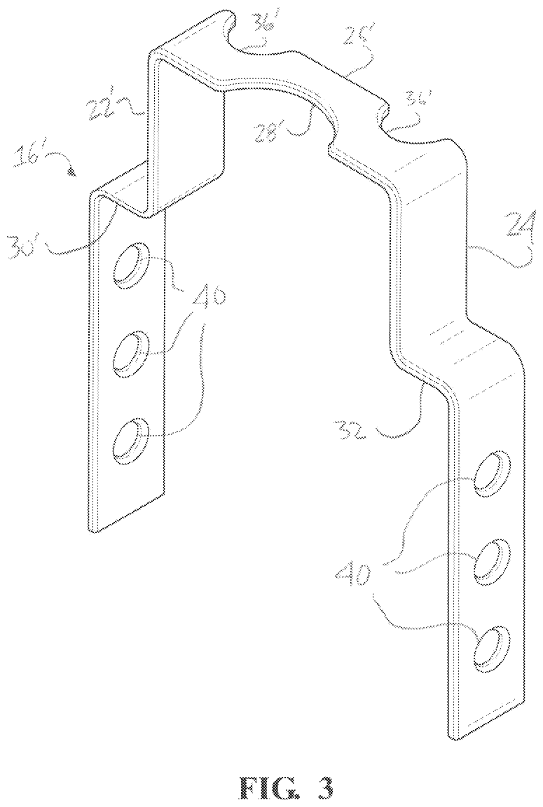

Referring to FIG. 3, wherein like primed reference numerals represent similar elements as the first embodiment of the invention, a second embodiment of the block stacking assembly is generally shown at 16'. The difference between the first 16 and second 16′ embodiments relates how the block stacking assembly 16′ is anchored to the extender block 14. In the first embodiment, the weight of the extender block 14 held the first 18 and second 20 base flanges in place and against the ground surface (not shown). In the second embodiment, the side arms 22′, 24′ do not extend from the first 18 and second 20 base flanges. In the second embodiment, the block stacking assembly 16′ includes a plurality of holes 40 extending through each of the first 22′ and second 24′ side arms. The side arms 22', 24′ are inserted directly into the extender block 14 and the medium that is inside the extender block 14 moves into the plurality of holes 40 and anchors the block stacking assembly 16′ in place.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A block stacking assembly securing a starter block of growing medium to an extender block of growing medium, said block stacking assembly comprising:
first and second base flanges extendable under the extender block such that the extender block secures said block stacking assembly in place;
first and second side arms extending upwardly from said first and second bases, respectively; and
a cross member connecting said first side arm to said second side arm over the starter block.

2. The block stacking assembly as set forth in claim 1 wherein said first and second side arms are coplanar.

3. The block stacking assembly as set forth in claim 2 wherein at least one of said first and second side arms extends through a sidearm bend allowing said block stacking assembly to extend alongside the starter and extender blocks when stacked upon each other and in use.

4. The block stacking assembly as set forth in claim 3 wherein said cross member includes a trunk relief allowing the block stacking assembly to be mounted close to a center of the starter block.

5. The block stacking assembly as set forth in claim 4 wherein said cross member includes at least one waterline cut-away.

6. A block stacking assembly securing a starter block of growing medium to an extender block of growing medium, said block stacking assembly comprising:
first and second side arms extending parallel to each other, each of said first and second arm including a plurality of holes extending therethrough; and
a cross member connecting said first side arm to said second side arm over the starter block.

7. The block stacking assembly as set forth in claim 6 wherein said first and second side arms are coplanar.

8. The block stacking assembly as set forth in claim 7 wherein at least one of said first and second side arms extends through a sidearm bend allowing said block stacking assembly to extend alongside the starter and extender blocks when stacked upon each other and in use.

9. The block stacking assembly as set forth in claim 8 wherein said cross member includes a trunk relief allowing the block stacking assembly to be mounted close to a center of the starter block.

10. The block stacking assembly as set forth in claim 9 wherein said cross member includes at least one waterline cut-away.
